(19) United States
(12) Patent Application Publication
(10) Pub. No.: US 2009/0109392 A1
(43) Pub. Date: Apr. 30, 2009

(54) LIQUID CRYSTAL MIXTURE FOR PSA PROCESS AND LIQUID CRYSTAL DISPLAY DEVICE

(76) Inventors: Chung-Ching Hsieh, Hsin-Chu (TW); Chia-Hsuan Pai, Hsin-Chu (TW); Te-Sheng Chen, Hsin-Chu (TW)

Correspondence Address: NORTH AMERICA INTELLECTUAL PROPERTY CORPORATION, P.O. BOX 506, MERRIFIELD, VA, 22116, US

(21) Appl. No.: 12/190,600

(22) Filed: Aug. 13, 2008

(30) Foreign Application Priority Data
Oct. 24, 2007 (TW) 096139899

(51) Int. Cl. G02F 1/133; C09K 19/30; C09K 19/38; C09K 19/32

(52) U.S. Cl. 349/183; 252/299.63; 252/299.62

(57) ABSTRACT

A liquid crystal mixture for a polymer stability alignment process includes at least a set of first liquid crystal compounds without any double bond, at least a set of second liquid crystal compounds having double bonds, and at least a set of reactive monomers having methacrylate group. The concentration of the second liquid crystal compounds is about 0.1-20% by weight of the total weight of the liquid crystal compounds.

### BACKGROUND OF THE INVENTION

1. Field of the Invention

The present invention is relates to a liquid crystal mixture applied to a polymer stability alignment (PSA) process, and more particularly, to a liquid crystal mixture having liquid crystal (LC) molecules with double bonds and reactive monomers with methacrylate.

2. Description of the Prior Art

As liquid crystal displays (LCDs) have advantages of small volume and light weight, they are applied in various electrical products, such as cell phones, personal digital assistances (PDAs), and notebooks. Since large-size LCDs had been quickly developed, LCDs have become the main stream in the display market. However, the visual angle of traditional LCDs is not sufficiently wide to ensure high display quality, resulting in limiting the development of LCDs. A multi-domain vertical alignment (MVA) LCD panel is therefore made to increase the visual angle, which has wide visual angle and low response time and becomes the main products in the market of large-size flat display.

In a conventional MVA LCD panel, a plurality of protrusions is disposed on the inner surfaces of the upper and lower substrates to make the LC molecules have a pre-tilt angle. Accordingly, processes such as thin film deposition, photolithography process, and etching process are needed to form the protrusions, and thus complexity and cost of the fabrication are increased. Moreover, the protrusions have disadvantages of shading light, reducing aperture ratio, and reducing brightness of the MVA LCD.

Therefore, a polymerization alignment process, also named polymer stability alignment or phase separation alignment (PSA) process, is developed to provide polymers for replacing the protrusions of the conventional MVA LCD and thus to make the LC molecules have a pre-tilt angle in the display panel. The polymerization alignment process comprises providing reactive monomers in the liquid crystal mixture, and illuminating or heating the reactive monomers to promote a polymerization so that the LC molecules will have a pre-tilt angle. However, the conventional PSA LCD panels have a common problem that their liquid crystal materials have a high rotational viscosity, resulting in long response time and poor performance of the LCD panel. As a result, how to fabricate LCD panels with wide visual angle and short response time through simple and low-cost processes is still an important issue for the LCD manufacturers.

### SUMMARY OF THE INVENTION

It is therefore a primary objective of the claimed invention to provide a liquid crystal mixture having a specific composition of liquid crystal compounds with double bonds and reactive monomers in order to improve the above-mentioned disadvantages of long response time, resulted from the high rotational viscosity, of the prior-art PSA LCD panel.

According to the claimed invention, a liquid crystal mixture applied for a PSA process is provided. The liquid crystal mixture comprises at least a set of first liquid crystal compounds without any double bond, at least a set of second liquid crystal compounds with double bonds, and at least a set of reactive monomers with methacrylate. The concentration of the second liquid crystal compound is in a range of about 0.1 to 20% by weight (wt %) of the total liquid crystal compounds.

It is an advantage of the claimed invention that the liquid crystal mixture comprises the second liquid crystal compounds with double bonds so that the rotational viscosity of the whole liquid crystal mixture can be effectively lowered so as to improve the response time of the LC molecules. In addition, with the coordination of the second liquid crystal compounds with a specific concentration and the reactive monomers with methacrylate, the claimed invention liquid crystal mixture provides a good alignment performance in the PSA process, such that the total fabrication cost and display quality of the LCD panel are improved as well.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-3 are schematic diagrams of the fabrication process of the LCD panel according to the present invention.

FIG. 4 and FIG. 5 are curve charts of response time versus driving voltage of the present invention LCD panel and the prior-art LCD panel respectively.

### DETAILED DESCRIPTION

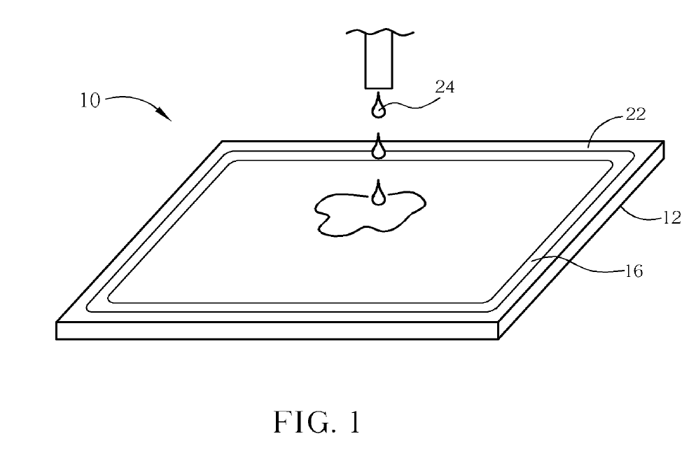

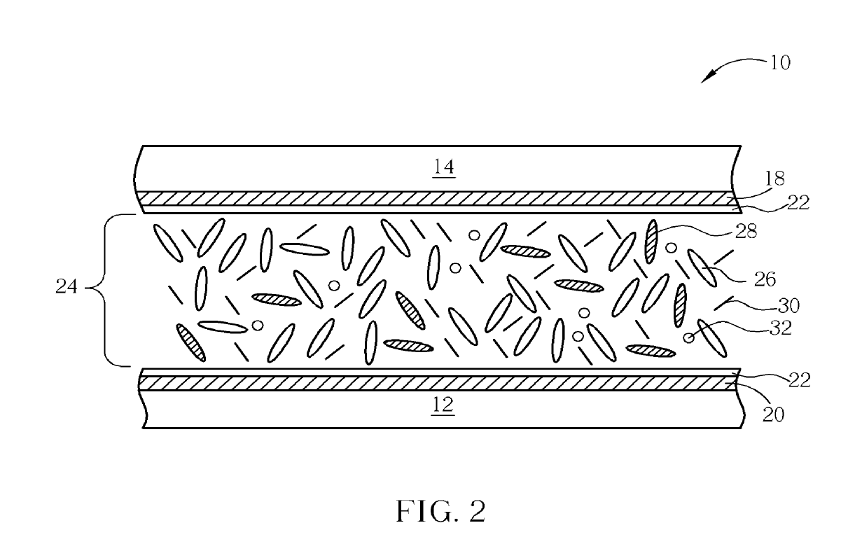

With reference to FIGS. 1-3, FIGS. 1-3 are schematic diagrams of the fabrication process of an LCD panel 10 with the liquid crystal mixture of the present invention. As shown in FIG. 1, first, two transparent substrates are provided for serve as the lower substrate 12 and the upper substrate 14 (shown in FIG. 2) of the present invention LCD panel 10. On the upper surface of the lower substrate 12, pluralities of electric devices such as thin film transistors, driving ICs, scan lines, and data lines are disposed (not shown). On the other hand, the substrate 14 may comprise color filters (not shown) positioned on its lower surface. After the upper substrate 14 and the lower substrate 12 are cleaned, alignment films 22 may be printed on the inner surfaces of the upper and lower substrates 14, 12 individually. Then, one-drop fill (ODF) process may be applied to fill the present invention liquid crystal mixture 24 between the upper and lower substrates 14, 12, and the LCD panel 10 is assembled. However, the liquid crystal mixture 24 of the present invention may also be filled between the upper substrate 14 and the lower substrate 12 through a traditional liquid crystal injection process for assembling the LCD panel 10. The ODF process includes coating a sealant 16 on the upper surface of the lower substrate 12, dropping the present invention liquid crystal mixture 24 onto the upper surface of the lower substrate 12, enclosed by the sealant 16, covering the lower substrate 12 by the upper substrate 14, and performing an illuminating or curing process to cure the sealant 16, so as to complete the assembly of the LCD panel 10. Then, the assembled LCD panel 10 may be cut, attached with circuit boards, such as flexible printed circuit boards, and encased with a housing or a frame for using as an LCD device.

Referring to FIG. 2, FIG. 2 is a partial sectional view of the assembled LCD panel 10. Conductive layers 18 and 20 are deposed on the inner surfaces of the upper substrate 14 and the lower substrate 12 for serving as a common electrode and a pixel electrode respectively. The detail structure for the upper substrate 14 and the lower substrate 12 is well known by a person skilled in the art, and would not be explained in detail. In addition, the liquid crystal mixture 24 of the present invention comprises at least a set of first liquid crystal compounds 26 without double bonds, at least a set of second liquid crystal compounds 28, at least a set of reactive monomers 30 with methacrylate, and at least a set of polymerization initiators 32, wherein each of the second liquid crystal compounds 28 has at least a double bond. The reactive monomers 30 are thermal-polymerizable or photo-polymerizable reactive monomers, and the polymerization initiator 32 has a concentration of X that preferably satisfies 0%≦X≦0.002% by weight of the liquid crystal mixture 24 approximately. According to the present invention, in order to improve the disadvantage of long response time of the conventional PSA LCD panel, the present invention liquid crystal mixture 24 especially includes the second liquid crystal compounds 28 having alkenes with double bonds, which have a functionality of lower the viscosity of a compound mixture, such that the rotational viscosity of the liquid crystal mixture 24 can be effectively reduced for improving the response time of the LC molecules. The chemical structure formula of the second liquid crystal compounds 28 used for reducing the viscosity will be clearly introduced thereinafter.

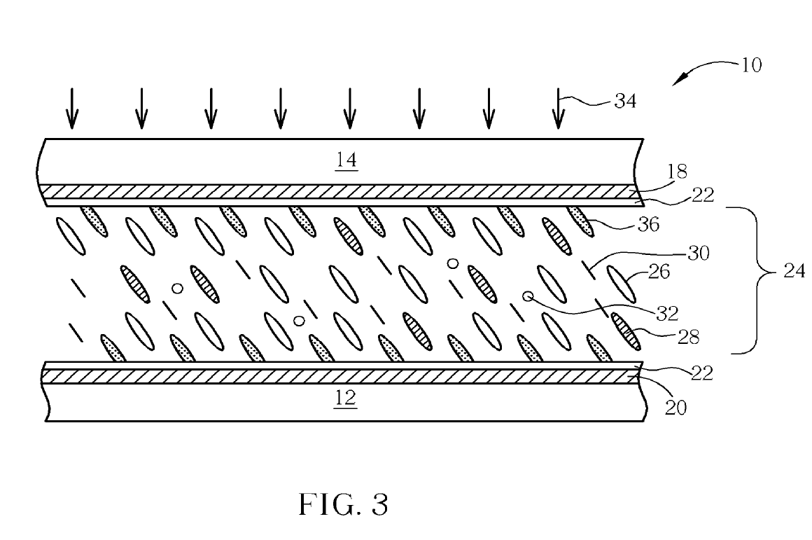

Referring to FIG. 3, after the assembly of the LCD panel 10, a PSA process or a polymerization alignment process is performed as the following steps. First, a voltage such as a DC voltage or an AC voltage is repeatedly applied on the conductive layers 18, 20 of the upper and lower substrates 14, 12 for providing electric fields to the liquid crystal mixture 24 to make the LC molecules, such as the first liquid crystal compounds 26 and the second liquid crystal compounds 28 rotate to a predetermined angle. Then, a light 34, or heat, is applied on the LCD panel 10 while the voltage is still applied on. Accordingly, the reactive monomers 30 of the liquid crystal mixture 24 polymerize along the predetermined angle for the LC molecules and the polymers 36 are formed on the surfaces of the upper and lower substrates 14, 12 by the reactive monomers 30, such that a phase separation is caused, as shown in FIG. 3. Since the polymers 36 are arranged along the arrangement direction of the LC molecules with the predetermined angle on the alignment films 22 on the surfaces of the upper and lower substrates 14, 12, they can substantially replace the protrusions of the prior-art MVA LCD panel that provide a pre-tilt angle for the LC molecules. Accordingly, the manufacturing of the LCD panel 10 of the present invention is completed.

As mentioned above, in order to shorten the response time of the present invention LCD panel 10, the liquid crystal mixture 24 of the present invention comprises a set of second liquid crystal compounds 28, wherein each of the second liquid crystal compounds 28 has at least a double bond. The second liquid crystal compounds 28 preferably comprise at least a compound of structural formula (1):

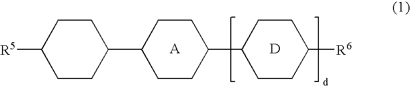

wherein R⁵ is an alkenyl having 2 to 8 carbon atoms; R⁶ is an alkyl having 1 to 12 carbon atoms, and the 1 or 2 non-adjacent CH₂ group of R⁶ is replaceable with —O—, —CH═CH—, —CO—, —OCO— or —COO—, in such a way that oxygen (O) atoms are not directly linked with each other; d is 0 or 1; and

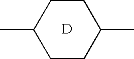

is a phenyl or a phenyl with halogen, such as

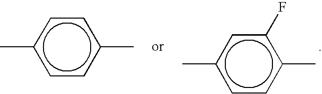

More specifically, the second liquid crystal compounds 28 preferably comprise compounds of formula (1-1) or formula (1-2) or formula (1-3)

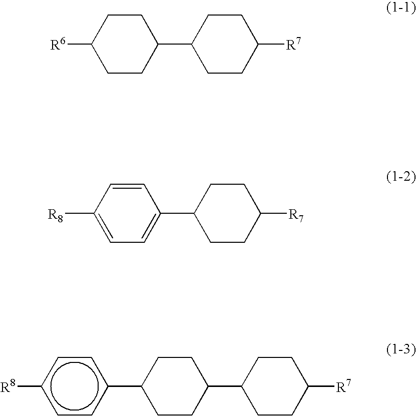

wherein R⁷ is an alkenyl having 2 to 8 carbon atoms, and R⁸ is an alkyl having 1 to 8 carbon atoms.

On the other hand, the first liquid crystal compounds 26 may comprise one or more compounds of formulas (2), (3), and (4):

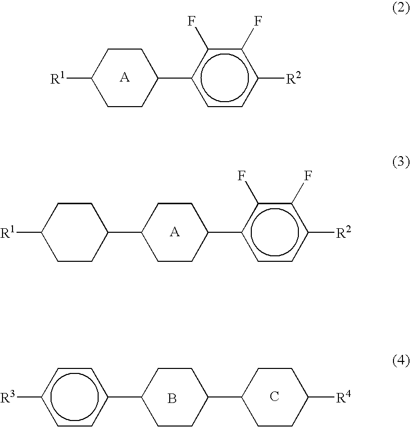

wherein R¹, R², R³, and R⁴ are each, independently of one another, an alkyl having 1 to 12 carbon atoms, and 1 or 2 non-adjacent CH₂ group of R¹, R², R³, and R⁴ are optionally replaced by —O—, —CH═CH—, —CO—, —OCO— or —COO— in such a way that O atoms are not linked directly to one another;

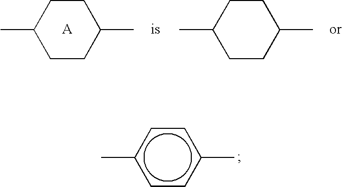

and

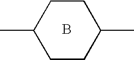

and

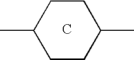

independently are

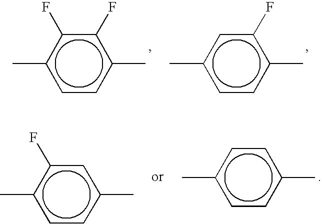

It should be noted that the existence of the second liquid crystal compounds 28 with double bonds in the liquid crystal mixture 24 influences the content and composition of other materials of the liquid crystal mixture 24. In order to prevent the liquid crystal mixture 24 including the second liquid crystal compounds 28 from poorly polymerizing or misaligning during the polymerization process, a specific prescription with compositions and concentrations of specific liquid crystal compounds and the reactive monomers 30 is provided for the liquid crystal mixture 24 according to the present invention. In a preferable embodiment of the present invention, the second liquid crystal compound 28 preferably has a concentration with a range of about 0.1 to 20% by weight of the total weight of the liquid crystal compounds in the liquid crystal mixture 24. For example, the composition of liquid crystal compounds of the present invention liquid crystal mixture 24 may comprise about 30 to 70 wt % of the compounds of formula (2), about 10 to 50 wt % of the compounds of formula (3), about 20 to 60 wt % of the compounds of formula (4), and about 0.1 to 20 wt % of the second liquid crystal compounds 28, wherein the unit “wt %” of the weight percentage of the concentration is based on the total weight of the liquid crystal compounds in the liquid crystal mixture 24.

On the other hand, the present invention reactive monomers 30 preferably comprise at least a compound of formulas (5), (6), (7), (8), or (9) and the polymeric component in liquid crystal mixture has a concentration Y that satisfies 0.1%≦y≦10% (% by weight).

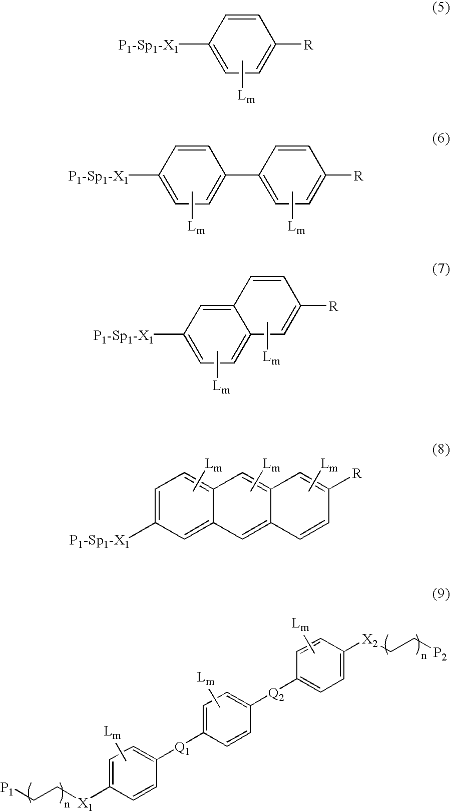

wherein R is hydrogen (H), fluorine (F), chlorine (Cl), cyanogen (CN), SCN, —SF₅H, NO₂, straight-chain or branched-chain alky having 1 to 12 carbon atoms, or —X₂-Sp₂-P₂; X₁ and X₂ independent are —O—, —S—, —OCH₂—, —CO—, —COO—, —OCO—, —CO—N⁰R—, —N⁰R—CO—, —SCH₂—, —CH₂S—, —CH═CH—COO—, —OOC—CH═CH— or a single bond; P₁ and P₂ independently are a polymerizable group, and one of P₁ or P₂ is preferable a methacrylate, or both the P₁ and P₂ are methacrylate; Sp₁ and Sp₂ independently are a spacer group or a single group; Lm independently is F, Cl, CN, or alkyl, alkylcarbonyl, alkoxycarbonyl or alkylcarbonyloxy having 1 to 7 carbon atoms; m≧1; n≧1; and Q₁, Q₂ independently are —O—, —S—, —CO—, —COO—, —OCO—, —OCH₂—, —SCH₂—, —CH₂S—, —CH═CH—COO—, —OOC—CH═CH—, —CF₂O—, —OCF₂—, —CF₂S—, —SCF₂—, —C₂H₄—, —CF₂ CH₂—, —CH₂ CF₂—, —CF₂ CF₂—, —CH═CH—, —CF═CF—, —C≡C— or a single bond. In addition, when R is a straight-chain or a branched-chain alkyl having 1 to 12 carbon atoms, one or two non-adjacent CH₂ group is replaceable with —O—, —S—, —CH═CH—, —CO—, —OCO—, —COO—, —S—CO—, —CO—S— or —C≡C— (alkyne) in such away that and/or S atoms are not linked directly to one another. When L is alkyl, alkylcarbonyl, alkoxycarbonyl or alkylcarbonyloxy having 1 to 7 carbon atoms, one or more H atoms of which may be replaced by F or Cl. More specifically, in a preferable embodiment of the present invention, the reactive monomers 30 may comprise the compound of formula (10):

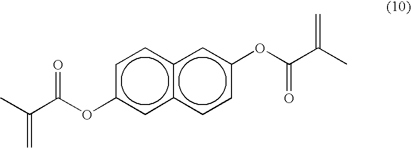

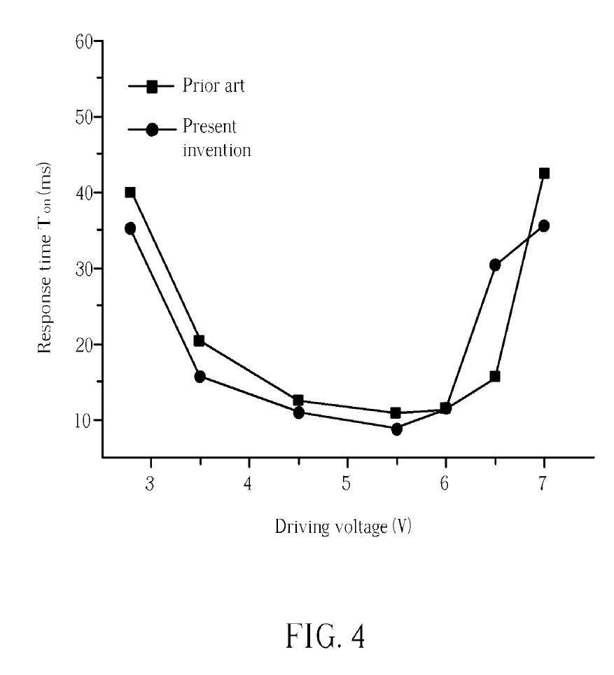

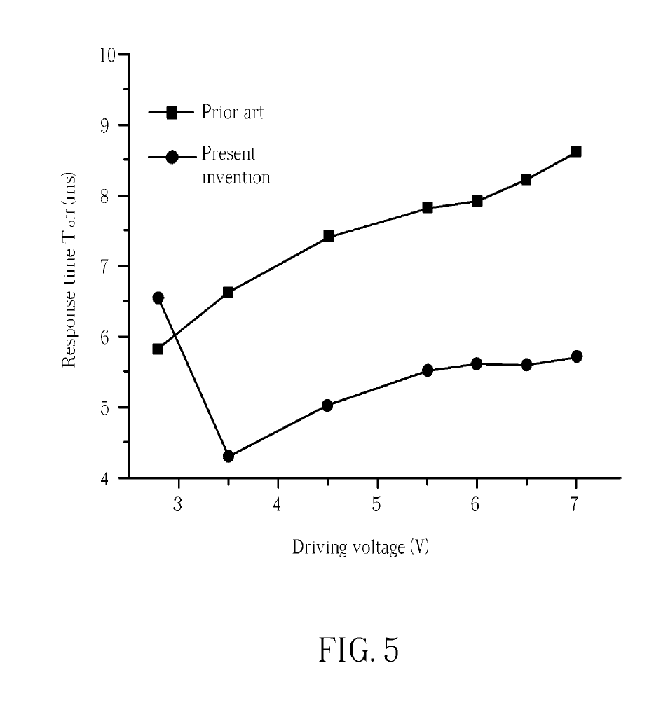

Since the present invention liquid crystal mixture 24 comprises the reactive monomers 30 of formulas (5), (6), (7), (8), or (9) and the second liquid crystal compounds 28 with a specific concentration, the rotational viscosity of the liquid crystal mixture 24 is effective reduced, and therefore the response time of the LCD panel 10 is shortened and the alignment performance of the LC mixture 24 is improved. The curve charts of the response time versus driving voltage of the present invention LCD panel 10 and the prior-art LCD panel are shown in FIGS. 4-5. FIG. 4 represents the response time Tₒₙ of applying a driving voltage on the LCD panel to make LC molecules lie down and be parallel with the upper and lower substrates. As shown in FIG. 4, the response time Tₒₙ of the present invention LCD panel 10 are mostly shorter than that of the prior-art LCD panel, though it is a little longer than that of the prior-art LCD panel only under a driving voltage of 6 to 7 volts. Referring to FIG. 5, FIG. 5 shows the response time T_{off} of LC molecules flipping back to the original alignment direction with the pre-tilt angle when the driving voltage is removed. The response time T_{off} of the present invention LCD panel 10 is quite shorter than that of the prior-art LCD panel of about 3 to 4 milliseconds, as shown in FIG. 5, and it is because the present invention liquid crystal mixture 24 comprises the reactive monomers 30 and the second liquid crystal compounds 28 with the functionality of reducing viscosity of mixtures. As a result, the rotational viscosity of the liquid crystal mixture 24 can be effectively lowered and the response time T_{off} is obviously shortened.

In contrast to the prior art, the present invention provides a liquid crystal mixture or an LCD device having said liquid crystal mixture comprising a set of section liquid crystal compounds with double bonds and methacrylate reactive monomers, while the second liquid crystal compounds have a specific concentration in said liquid crystal mixture. Accordingly, the rotational viscosity of the liquid crystal mixture can be effective lowered to improve the whole performance of response time of the LCD device, further more to improve the alignment performance of the LC molecules during the PSA process. As a result, a LCD device has a low fabrication cost with simple fabrication process, wide visual angle, and short response time is provided according to the present invention.

Those skilled in the art will readily observe that numerous modifications and alterations of the device and method may be made while retaining the teachings of the invention.

What is claimed is:

1. A liquid crystal mixture of a polymer stability alignment (PSA) process, comprising:
at least a set of first liquid crystal compounds without any double bond;
at least a set of second liquid crystal compounds, each of which has at least a double bond, the second liquid crystal compounds having a concentration in a range of about 0.1-20% by weight (wt %) of a total weight of the set of the first and second liquid crystal compounds; and
at least a set of reactive monomers having methacrylate groups.

2. The liquid crystal mixture of claim 1, wherein the second liquid crystal compounds comprise at least a compound of formula (1): 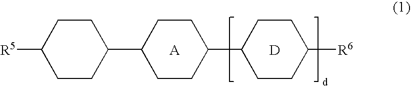
wherein R⁵ is alkyl having 18 carbons or an alkenyl having 2 to 8 carbon atoms;
R⁶ is an alkyl having 1 to 12 carbon atoms;
d is 0 or 1; and 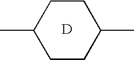
is a phenyl or a phenyl with halogen.

3. The liquid crystal mixture of claim 2, wherein 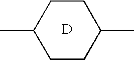
is

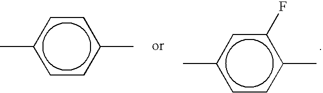

4. The liquid crystal mixture of claim 2, wherein 1 or 2 non-adjacent CH₂ group of R⁶ is replaced by —O—, —CH═CH—, —CO—, —OCO—, or —COO—, in such a way that oxygen (O) atoms are not linked directly to one another.

5. The liquid crystal mixture of claim 2, wherein the second liquid crystal compounds comprises of a compound of formula (1-1), a compound of formula (1-2) or a compound of formula (1-3) 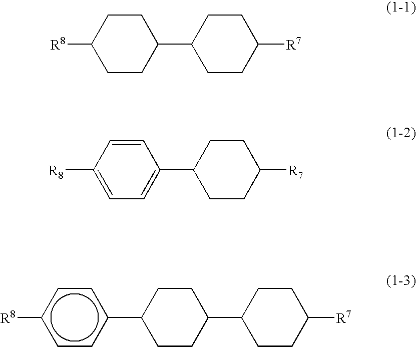
wherein R⁷ is an alkenyl having 2 to 8 carbon atoms, and R⁸ is an alkyl having 1 to 8 carbon atoms.

6. The liquid crystal mixture of claim 1, wherein the first liquid crystal compounds comprise one or more compounds of formula (2), formula (3), or formula (4): 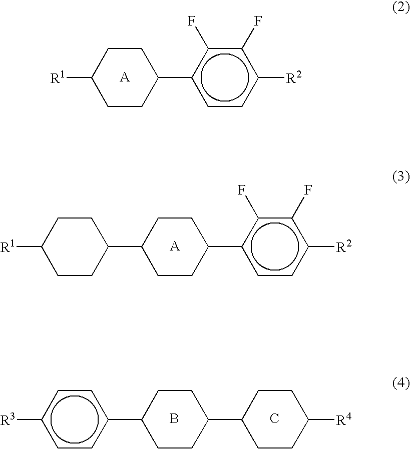
wherein R¹, R², R³, R⁴ independently are alkyl having 1 to 12 carbon atoms; 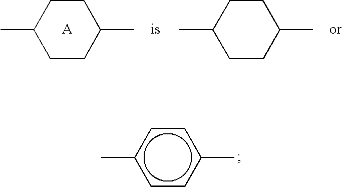
and 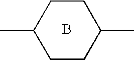
and 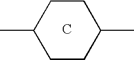
independently are

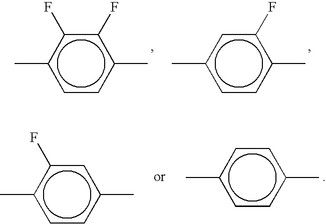

7. The liquid crystal mixture of claim 6, wherein 1 or 2 non-adjacent group of R¹, R², R³, R⁴ is optionally replaced by —O—, —CH═CH—, —CO—, —OCO—, or —COO—, in such a way that O atoms are not linked directly to one another.

8. The liquid crystal mixture of claim 6, wherein a composition of the liquid crystal mixture comprises:
about 30 to 70 wt % of the compounds of formula (2);
about 10 to 50 wt % of the compounds of formula (3);
about 20 to 60 wt % of the compounds of formula (4); and
about 0.1 to 20 wt % of the second liquid crystal compounds;
wherein the weight percentage of concentration wt % is based on a total weight of liquid crystal compounds.

9. The liquid crystal mixture of claim 1, wherein the reactive monomers comprise compounds of (5), (6), (7), (8), or (9) and the polymeric component in liquid crystal mixture has a concentration Y that satisfies 0.1%≦y≦10% (% by weight). 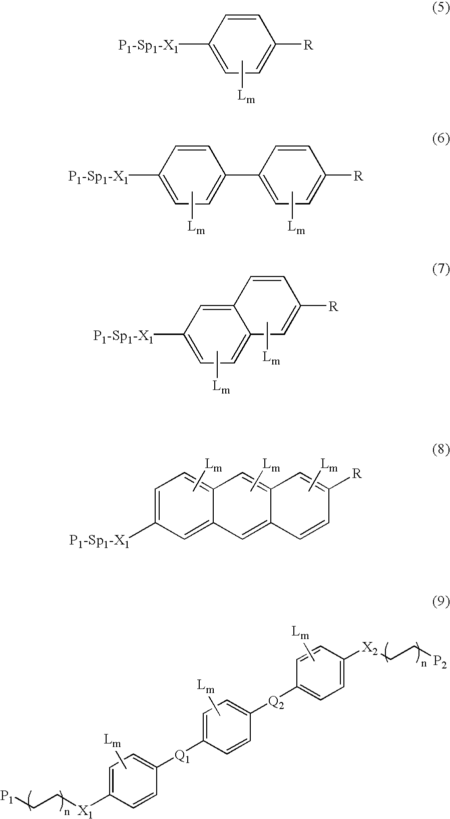
wherein R is hydrogen (H), fluorine (F), chlorine (Cl), cyanogen (CN), SCN, —SF₅H, NO₂, straight-chain or branched-chain alkyl having 1 to 12 carbon atoms, or —X₂-Sp₂-P₂;
X₁ and X₂ independently are —O—, —S—, —OCH₂—, —CO—, —COO—, —OCO—, —CO—N⁰R—, —N⁰R—CO—, —SCH₂—, —CH₂S—, —CH═CH—COO—, —OOC—CH═CH— or a single bond;
P₁ and P₂ independently are a polymerizable group;
Sp₁ and Sp₂ independently are a spacer group or a single group;
Lm independently is F, Cl, CN, or alkyl, alkylcarbonyl, alkoxycarbonyl, or alkylcarbonyloxy having 1 to 7 carbon atoms;
m≧1;
n≧1; and
Q₁, Q₂ independently are —O—, —S—, —CO—, —COO—, —OCO—, —OCH₂—, —SCH₂—, —CH₂S—, —CH═CH—COO—, —OOC—CH═CH—, —CF₂O—, —OCF₂—, —CF₂S—, —SCF₂—, —C₂H₄—, —CF₂ CH₂—, —CH₂ CF₂—, —CF₂ CF₂—, —CH═CH—, —CF═CF—, —C≡C—, or a single bond.

10. The liquid crystal mixture of claim 9, wherein when R is straight-chain or branched alkyl having 1 to 12 carbon atoms, 1 or 2 non-adjacent CH₂ group of R is replaced by —O—, —S—, —CH═CH—, —CO—, —OCO—, —COO—, —S—CO—, —CO—S—, or alkyne (—C≡C—), in such a way that O and/or S atoms are not linked directly to one another.

11. The liquid crystal mixture of claim 9, wherein P₁ or P₂ is a methacrylate.

12. The liquid crystal mixture of claim 11, wherein P₁ and P₂ are both methacrylate.

13. The liquid crystal mixture of claim 9, wherein when L is alkyl, alkylcarbonyl, alkoxycarbonyl, or alkylcarbonyloxy having 1 to 7 carbon atoms, one or more H atoms of which is replaced by F or Cl.

14. The liquid crystal mixture of claim 1, wherein the reactive monomers are thermal-polymerizable or photo-polymerizable reactive monomers.

15. The liquid crystal mixture of claim 1, further comprising a set of initiators having a concentration of X, satisfying 0%≦x≦0.002% by weight.

16. A PSA liquid crystal display device, comprising:
an upper substrate and a lower substrate; and
a liquid crystal mixture disposed between the upper substrate and the lower substrate, comprising:
at least a set of first liquid crystal compounds without any double bond;
at least a set of second liquid crystal compounds, each of which has at least a double bond, the second liquid crystal compounds having a concentration of about 0.1 to 20% by weight of a total weight of the sets of the first and second liquid crystal compounds of the liquid crystal mixture; and
at least a set of reactive monomers having methacrylate.
